(19) United States
(12) Patent Application Publication
(10) Pub. No.: US 2010/0233374 A1
(43) Pub. Date: Sep. 16, 2010

(54) METHOD OF PRODUCING INKJET RECORDING MEDIUM

(75) Inventor: Hiroshi KAWAKAMI, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/721,581

(22) Filed: Mar. 11, 2010

(30) Foreign Application Priority Data
Mar. 13, 2009 (JP) 2009-061395

(51) Int. Cl. B05D 3/10; B05D 3/00

(52) U.S. Cl. 427/337; 427/374.1

(57) ABSTRACT

A method of producing an inkjet recording medium includes: preparing a first coating liquid by mixing an aqueous solution of an acetoacetyl-modified polyvinyl alcohol with a zirconium compound-containing liquid including inorganic fine particles and a zirconium compound; and forming a coating layer by applying the first coating liquid onto a substrate.

### CROSS-REFERENCE TO RELATED APPLICATION

This application claims priority under 35 USC 119 from Japanese Patent Application No. 2009-061395, filed on Mar. 13, 2009, the disclosure of which is incorporated by reference herein.

### BACKGROUND OF THE INVENTION

1. Field of the Invention

The present invention relates to a method of producing an inkjet recording medium.

2. Description of the Related Art

With recent rapid advances in the information technology industry, various information-processing systems have been developed, and recording techniques and apparatuses which are suitable for the information-processing systems have been put into practical use.

Among these recording techniques, inkjet recording methods have been widely used in homes as well as in offices because the inkjet recording methods have the advantages that they enable recording on various recording materials on which an image or the like is to be recorded, hardware (i.e., apparatuses) for the inkjet recording is relatively inexpensive and space-saving, little noise is made, and the like.

Recently, owing to the realization of high-resolution inkjet printers, “photograph-like” high-quality recorded images can be obtained. Together with these advances in hardware (apparatuses), various inkjet recording sheets have been developed.

In general, inkjet recording sheets are required to have characteristics including: (1) quick-drying property (i.e., high absorption speed of ink), (2) an adequate and uniform dot diameter of ink dots (free from bleeding), (3) excellent granularity, (4) high dot sphericity, (5) high color density, (6) high color saturation (no dullness), (7) excellent water resistance, light resistance and ozone resistance of an image portion, (8) high whiteness of recording sheets, (9) high storage stability (free from yellowing and bleeding of an image during long-term storage; bleeding over time is ameliorated), (10) resistance to deformation; that is, high dimensional stability (low curling) and (11) excellent conveyance properties through hardware.

Furthermore, when an inkjet recording sheet is used as gloss photo paper that is used for obtaining a “photograph-like” high-quality recorded image, the inkjet recording sheet is required to have glossiness, surface smoothness, and a texture like developing paper similar to that of silver halide photography, in addition to the above characteristics.

Specifically, an inkjet recording medium has been disclosed in which no cracking is generated in a coating film and which has excellent ink absorbency (see, for example, Japanese Patent Application Laid-Open (JP-A) No. 2004-114457). The inkjet recording medium has a substrate and an ink receiving layer which is provided on the substrate and which contains inorganic ultrafine particles, an acetoacetyl-modified polyvinyl alcohol, and a zirconium compound.

### SUMMARY OF THE INVENTION

The inkjet recording medium disclosed in JP-A No. 2004-114457 does not have satisfactory properties from the viewpoints of stability over time of a coating liquid used for forming an ink receiving layer and brittleness of the inkjet recording medium.

The present invention has been made in view of the above circumstances and provides a method of producing an inkjet recording medium.

According to a first aspect of the invention, there is provided a method of producing an inkjet recording medium, the method including: preparing a first coating liquid by mixing an aqueous solution of an acetoacetyl-modified polyvinyl alcohol with a zirconium compound-containing liquid containing inorganic fine particles and a zirconium compound; and forming a coating layer by applying the first coating liquid onto a substrate.

The present invention has been made in view of the above circumstances. In the following, a method of producing an inkjet recording medium is described.

### DETAILED DESCRIPTION OF THE INVENTION

### Method of Producing Inkjet Recording Medium

The method of producing an inkjet recording medium of the invention includes: preparing a first coating liquid by mixing an aqueous solution of an acetoacetyl-modified polyvinyl alcohol with a zirconium compound-containing liquid containing inorganic fine particles and a zirconium compound (first coating liquid preparation process); and forming a coating layer by applying the first coating liquid onto a substrate (coating layer formation process).

Since the method of producing an inkjet recording medium of the invention has the above configuration, an inkjet recording medium having low brittleness is produced using a coating liquid having excellent stability over time.

The method of producing an inkjet recording medium is described in detail below.

First Coating Liquid

The first coating liquid of the invention includes at least inorganic fine particles, a zirconium compound, and an acetoacetyl-modified polyvinyl alcohol, and may further include, as necessary, additional components.

Specifically, the first coating liquid is prepared by mixing an aqueous solution of an acetoacetyl-modified polyvinyl alcohol with a zirconium compound-containing liquid which contains inorganic fine particles and a zirconium compound. Such a preparation method imparts excellent temporal stability to the first coating liquid, and enables production of an inkjet recording medium having low brittleness using the coating liquid having excellent temporal stability. For example, the first coating liquid may be prepared by adding an aqueous solution of an acetoacetyl-modified polyvinyl alcohol with a zirconium compound-containing liquid which contains inorganic fine particles and a zirconium compound.

Zirconium Compound-Containing Liquid

The zirconium compound-containing liquid includes at least one zirconium compound and at least one kind of inorganic fine particles, and may further include, as necessary, additional components.

The zirconium compound-containing liquid preferably has a pH (at 25° C.) of from 4.5 to 6 from a viewpoint of storage stability of the first coating liquid obtained using the zirconium compound-containing liquid.

The pH of the zirconium compound-containing liquid may be adjusted using, for example, an amino group-containing compound. In particular, the pH is preferably adjusted using ammonia or an ammonium compound from a viewpoint of suppressing bleed.

Zirconium Compound

The zirconium compound to be used in the invention is not particularly limited, and various zirconium compounds may be used.

Examples of the zirconium compound to be used in the invention include zirconyl hydroxy chloride, zirconyl chloride, zirconyl nitrate, zirconyl acetate, ammonium zirconyl carbonate, basic zirconium carbonate, zirconium hydroxide, potassium zirconium carbonate, zirconium sulfate, and fluorinated zirconium compounds.

Of these zirconium compounds, from the viewpoint of liquid-stability of the first coating liquid, at least one selected from the group consisting of zirconyl hydroxy chloride, zirconyl chloride, zirconyl nitrate, zirconyl acetate, and ammonium zirconyl carbonate is preferable, and zirconyl hydroxy chloride or zirconyl acetate is more preferable.

Inorganic Fine Particles

The zirconium compound-containing liquid includes at least one kind of inorganic fine particles.

When an ink receiving layer of an inkjet recording medium is formed using the first coating liquid including the zirconium compound-containing liquid containing the inorganic fine particles, the ink receiving layer has a porous structure owing to the incorporation of the inorganic fine particles. As a result, ink absorbency and image stability are improved.

In particular, the content ratio, in terms of solid content, of the inorganic fine particles in the ink receiving layer is preferably 50% by mass or more, and more preferably more than 60% by mass; with such a content ratio of the inorganic fine particles, a further preferable porous structure may be formed, and an inkjet recording medium having sufficient ink absorbency may be obtained. The content ratio, in terms of solid content, of the inorganic fine particles in the ink receiving layer indicates the content ratio of the inorganic fine particles calculated based on the total amount of the components other than water in the composition constituting the ink receiving layer.

Examples of the inorganic fine particles include silica fine particles, colloidal silica, titanium dioxide particles, barium sulfate fine particles, calcium silicate fine particles, zeolite fine particles, kaolinite fine particles, halloysite fine particles, mica fine particles, talc fine particles, calcium carbonate fine particles, magnesium carbonate fine particles, calcium sulfate fine particles, pseudoboehmite fine particles, zinc oxide fine particles, zinc hydroxide fine particles, alumina fine particles, aluminum silicate fine particles, calcium silicate fine particles, magnesium silicate fine particles, zirconium oxide fine particles, zirconium hydroxide fine particles, cerium oxide fine particles, lanthanum oxide fine particles, and yttrium oxide fine particles. Of these, from the viewpoint of forming a preferable porous structure, silica fine particles, colloidal silica, alumina fine particles, or pseudoboehmite particles are preferable. The fine particles to be used may be primary particles, or secondary particles formed therefrom. The fine particles have an average primary particle diameter of preferably 2 μm or less, and more preferably 200 nm or less.

The inorganic fine particles may more preferably be silica fine particles having an average primary particle diameter of 20 nm or less, colloidal silica having an average particle diameter of 30 nm or less, alumina fine particles having an average particle diameter of 20 nm or less, or pseudoboehmite fine particles having an average pore radius of from 2 nm to 15 nm, and particularly preferably be the silica fine particles, the alumina fine particles, or the pseudoboehmite fine particles.

In general, the silica fine particles are roughly classified into wet process silica particles and dry process (vapor-phase process) silica particles according to the production method thereof. In the wet process, a method of producing hydrous silica by forming active silica by acid decomposition of a silicate, polymerizing the active silica to a certain degree, and allowing the resultant polymerized product to aggregate and precipitate, is widely used. In the vapor-phase process, a method of producing anhydrous silica by high-temperature vapor-phase hydrolysis of a silicon halide (flame hydrolysis) or a method in which silica sand and coke are subjected to heat reduction and evaporation by arc in an electronic furnace and the resultant product is oxidized by air (arc process), are widely used. The “vapor-phase process silica” as used herein refers to anhydrous silica fine particles obtained by the vapor-phase processes. The silica fine particles to be used in the invention are particularly preferably the vapor-phase process silica fine particles.

The vapor-phase process silica differs from the hydrous silica in density of silanol groups on the surface thereof, the presence or absence of pores, and the like, and exhibits different properties from those of the hydrous silica. The vapor-phase process silica is suitable for forming three-dimensional structures having high porosity, though the reason is not clear. It may be because, while the hydrous silica fine particles tend to closely aggregate (i.e., form aggregates) owing to high silanol densities of from 5 groups/nm² to 8 groups/nm² on the fine particle surface, the vapor-phase process silica particles form loose aggregates (i.e., flocculates) owing to low silanol densities of from 2 groups/nm² to 3 groups/nm² on the fine particle surface, which results in formation of a highly-porous structure.

The vapor-phase process silica has high absorption and retaining efficiencies of ink owing to its particularly high specific surface area. Meanwhile, since the vapor-phase process silica has a low refractive index, a transparent receiving layer can be provided when the vapor-phase process silica is dispersed to an appropriate particle diameter, and high color density and favorable color exhibiting properties can be provided. The transparency of the receiving layer is important for applications which require transparency such as OHP application, as well as for an application to a recording medium such as gloss photo paper, from the viewpoints of obtaining high color density and favorable color exhibiting properties and glossiness.

The inorganic fine particles (especially the vapor-phase process silica) have an average primary particle diameter of preferably 30 nm or less, more preferably 20 nm or less, particularly preferably 10 nm or less, and most preferably from 3 nm to 10 nm. Especially, the vapor-phase process silica particles tend to adhere to each other via hydrogen bonding among the silanol groups. Therefore, the vapor-phase process silica can form a highly-porous structure when it has an average primary particle diameter is 30 nm or less, whereby ink absorbency can be effectively improved.

The silica fine particles may be used in combination with any of other fine particles mentioned above. When the vapor-phase process silica is used in combination with another kind of fine particles, the content of the vapor-phase process silica with respect to the total amount of the fine particles is preferably 30% by mass or more, and more preferably 50% by mass or more.

Also, the inorganic fine particles to be used in the invention may preferably be alumina particles, alumina hydrate fine particles, or a mixture or composite thereof. Of these, the alumina hydrate fine particles are preferable since they efficiently absorb and fix ink, and pseudoboehmite (Al₂O₃.nH₂O) fine particles are particularly preferable. Although various forms of alumina hydrate may be used, it is preferable to use a boehmite sol as a material of the alumina hydrate because flat and smooth layers can be easily formed.

Regarding pore structure of the pseudoboehmite, the pseudoboehmite has an average pore radius of preferably from 1 nm to 30 nm, and more preferably from 2 nm to 15 nm, and has a pore volume of preferably from 0.3 cc/g to 2.0 cc/g, and more preferably from 0.5 cc/g to 1.5 cc/g. Herein, the pore radius and pore volume may each be determined by the nitrogen adsorption/desorption method using, for example, a gas adsorption analyzer such as OMNISORP 369 (trade name, manufactured by Beckman Coulter, Inc.).

Of the alumina fine particles, vapor-phase process alumina fine particles are preferable since they have a large specific surface area. The vapor-phase process alumina fine particles have an average primary particle diameter of preferably 30 nm or less, and more preferably 20 nm or less.

In addition, colloidal silica having an average primary particle diameter of 30 nm or less is also preferably used in the invention.

The inorganic fine particles to be used in the invention are preferably silica fine particles, alumina fine particles, or pseudoboehmite fine particles.

When any of such fine particles are used for the inkjet recording medium, it is also preferable to use the fine particles in the embodiments as disclosed in, for example, Japanese Patent Application Laid-Open (JP-A) Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314.

Aqueous Solution of Acetoacetyl-Modified Polyvinyl Alcohol

The aqueous solution of an acetoacetyl-modified polyvinyl alcohol to be used in the invention includes at least one acetoacetyl-modified polyvinyl alcohol, and may further include, as necessary, additional components.

Acetoacetyl-Modified Polyvinyl Alcohol

The degree of acetoacetyl modification of the acetoacetyl-modified polyvinyl alcohol to be used in the invention is appropriately selected depending on the purpose, and is preferably from 0.1 mol % to 20 mol %.

In general, an acetoacetyl-modified polyvinyl alcohol is obtained by adding a liquid or gaseous diketene to a solution, dispersion liquid, or powder of a polyvinyl alcohol polymer and allowing them to react. However, the production method of the acetoacetyl-modified polyvinyl alcohol is not limited to this.

The acetoacetyl-modified polyvinyl alcohol to be used in the invention is not particularly limited as long as it is modified with an acetoacetyl group, and may be polyvinyl alcohol, which is obtained by saponification of a lower alcohol solution of polyvinyl acetate using a saponification catalyst such as an alkali, or, insofar as the effect of the present invention is not impaired, a derivative of the polyvinyl alcohol or a saponified product of a copolymer of vinyl acetate and a monomer that is copolymerizable with vinyl acetate.

Examples of the monomer that is copolymerizable with vinyl acetate include unsaturated carboxylic acids, such as maleic acid, maleic anhydride, fumaric acid, crotonic acid, itaconic acid, or (meth)acrylic acid, and esters of such unsaturated carboxylic acids; α-olefins such as ethylene or propylene; olefin sulfonic acids such as (meth)allyl sulfonic acid, ethylene sulfonic acid, or sulfonic acid maleate; alkaline metal salts of olefin sulfonic acids such as sodium (meth)allyl sulfonate, sodium ethylene sulfonate, sodium sulfonate (meth)acrylate, sodium sulfonate monoalkylmaleate, or sodium disulfonate alkylmaleate; amido group-containing monomers such as N-methylol acrylamide or an alkaline salt of acrylamide alkylsulfonate; and N-vinylpyrrolidone derivatives.

Examples of the acetoacetyl-modified polyvinyl alcohol which can be preferably used in the invention include GOHSEFIMER Z series (registered trademark, manufactured by Nippon Synthetic Chemical Industry Co., Ltd.). “(Meth)acrylic acid” means acrylic acid or methacrylic acid. “(Meth)acrylate” means acrylate or methacrylate. Other (meth)acrylic derivatives also indicate acrylic or methacrylic derivatives.

Optionally, the first coating liquid to be used in the invention may further include, as necessary, an additional water-soluble resin such as a modified or unmodified polyvinyl alcohol, other than the acetoacetyl-modified polyvinyl alcohol, to an extent that the effect of the present invention is not impaired.

Examples of the additional water-soluble resin include, in addition to the modified or unmodified polyvinyl alcohol, polymers having one type of functional group selected from, or two or more types of functional groups selected from, a carboxyl group, sulfoxyl group, or a reactive ketone group.

The polymer having a carboxyl group is obtained, for example, by homopolymerization or copolymerization of one or more monomers including at least one monomer having a carboxyl group. Examples of the monomer having a carboxyl group include (meth)acrylic acid, vinyl benzoate, maleic anhydride, and itaconic anhydride. Alternatively, a carboxyl group may be incorporated into a polymer through a polymeric reaction. For example, the polymer having a carboxyl group may be obtained by hydrolysis of a polymer obtained by homopolymerization or copolymerization of one or more monomers including at least one monomer having a carboxylic acid ester group, such as a (meth)acrylate (e.g., methyl (meth)acrylate, ethyl (meth)acrylate, butyl (meth)acrylate, or benzyl (meth)acrylate), or by addition of a carboxylic anhydride such as malonic anhydride, succinic anhydride, or trimellitic anhydride. Furthermore, the polymer having a carboxyl group may be a polysaccharide (such as alginic acid, pectin, or carboxymethylcellulose) or a gelatin.

The polymer having a sulfoxyl group is obtained by, for example, homopolymerization or copolymerization of one or more monomers including at least one monomer having a sulfoxyl group. Examples of the monomer having a sulfoxyl group include styrenesulfonic acid, (meth)acrylamide-2-methylpropanesulfonic acid, 3-sulfopropyl (meth)acrylate, and allylsulfonic acid. Furthermore, the water-soluble resin having a sulfoxyl group may be a polysaccharide, and specific examples thereof include carrageenan and agarose.

The water-soluble resin having a reactive ketone group is obtained by, for example, homopolymerization or copolymerization of one or more monomers including at least one monomer having a reactive ketone group. Examples of such a monomer include diacetone (meth) acrylamide.

The additional water-soluble resin may be used singly, or two or more of thereof may be used in combination.

The content of additional water-soluble resins may be within the above preferred content range described in connection with the acetoacetyl-modified polyvinyl alcohol.

Content Ratio of Inorganic Fine Particles to Water-Soluble Resin

The content ratio by mass (PB ratio (x/y)) of the inorganic fine particles (x) to the water-soluble resin (the total of the acetoacetyl-modified polyvinyl alcohol and the additional water-soluble resin(s), if any) (y) has a large influence on the film structure and the film strength of the ink receiving layer. In other words, a higher content ratio by mass (PB ratio) provides a higher porosity, a higher pore volume, and a larger surface area (per unit mass) while density and strength of the film tend to decrease.

The content ratio (PB ratio (x/y)) in the ink receiving layer is preferably in a range of from 1.5 to 10 from the viewpoints of preventing a decrease in film strength and the cracks while drying, which are caused by excessively high PB ratios, and avoiding a reduction in ink absorbency that results from decrease in porosity due to an increased tendency for pores to be clogged by the resins, which is caused by excessively low PB ratios.

When passing through a conveyance system of an inkjet printer, the recording sheet may sometimes receive stress. Therefore, the ink receiving layer is required to have adequate film strength. Moreover, the adequate film strength of the ink receiving layer is required also from the viewpoint of preventing cracking, exfoliating, and the like of the ink receiving layer when the recording medium is cut into sheets. In view of the above, the mass ratio (x/y) is preferably 5 or less, and, from the viewpoint of providing ability to rapidly absorb ink when the recording medium is used in an inkjet printer, the mass ratio (x/y) is more preferably 2 or more.

For example, when a coating liquid prepared by completely dispersing a vapor-phase process silica fine particles having an average primary particle diameter of 20 nm or less and an acetoacetyl-modified polyvinyl alcohol at a mass ratio (x/y) of from 2 to 5 in a solution is applied onto a substrate and dried, a three-dimensional network structure is formed having secondary particles of the silica fine particles as network chains, whereby a light-transmitting porous film having an average pore diameter of 25 nm or less, a porosity of from 50% to 80%, a specific pore volume of 0.5 ml/g or more, and a specific surface area of 100 m²/g or more can be easily formed.

Crosslinking Agent

The first coating liquid to be used in the invention includes at least one kind of inorganic fine particles, at least one zirconium compound, and at least one acetoacetyl-modified polyvinyl alcohol, and may further include a crosslinking agent that is capable of crosslinking the acetoacetyl-modified polyvinyl alcohol (and the additional water-soluble resin, if any). Incorporation of the crosslinking agent results in attainment of a cured porous ink receiving layer formed by crosslinking reaction of the water-soluble resin.

As the crosslinking agent, a crosslinking agent which is preferable in relation to the water-soluble resin included in the ink receiving layer may be appropriately selected. In particular, boron compounds are preferable from the viewpoint of rapidness of crosslinking reaction. Examples thereof include borax, boric acid, borates (such as orthoborate, InBO₃, ScBO₃, YBO₃, LaBO₃, Mg₃(BO₃)₂ or Co₃(BO₃)₂), diborates (such as Mg₂B₂O₅ or CO₂B₂O₅), metaborates (such as LiBO₂, Ca(BO₂)₂, NaBO₂, or KBO₂), tetraborates (such as Na₂B₄O₇.10H₂O), pentaborates (such as KB₅O₈.4H₂O or CsB₅O₅) and hexaborates (such as Ca₂B₆O₁₁.7H₂O). Of these, from the viewpoint of rapidness of crosslinking reaction, borax, boric acid, and borates are preferable, boric acid is particularly preferable, and it is most preferable to use such a crosslinking agent and, further, a polyvinyl alcohol, which is a water-soluble resin that can be added.

Examples of the crosslinking agent for crosslinking the water-soluble resin include, in addition to the boron compounds, those described below.

Examples of the crosslinking agent for crosslinking the water-soluble resin include: aldehyde compounds, such as formaldehyde, glyoxal and glutaraldehyde; ketone compounds, such as diacetyl and cyclopentanedione; active halogen compounds, such as bis(2-chloroethylurea)-2-hydroxy-4,6-dichloro-1,3,5-triazine and sodium salts of 2,4-dichloro-6-s-triazine; active vinyl compounds, such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds, such as dimethylolurea and methyloldimethylhydantoin; melamine resins, such as methylolmelamine and alkylated methylolmelamine; epoxy resins;

isocyanate compounds, such as 1,6-hexamethylene diisocyanate; the aziridine compounds described in U.S. Pat. Nos. 3,017,280 and 2,983,611; the carboxyimide compounds described in U.S. Pat. No. 3,100,704; epoxy compounds, such as glycerol triglycidyl ether; ethyleneimino compounds, such as 1,6-hexamethylene-N,N′-bisethyleneurea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chrome alum, potassium alum, and chromium acetate; polyamine compounds, such as tetraethylenepentamine; hydrazide compounds, such as adipic acid dihydrazide; low-molecular compounds each having at least two oxazoline groups; and polymers each having at least two oxazoline groups.

Furthermore, the crosslinking agent for the water-soluble resin in the invention may preferably be any of the following polyvalent metal compounds. The polyvalent metal compounds function as the crosslinking agent, and also improve ozone resistance and glossiness and prevent image bleeding.

The polyvalent metal compound is preferably water-soluble, and examples thereof include calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, ammonium cupric chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, aluminum sulfite, aluminum thiosulfate, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, chromium acetate, chromium sulfate, magnesium sulfate, magnesium chloride hexahydrate, magnesium citrate nonahydrate, sodium phosphotungstate, sodium tungsten citrate, 12-tungstophosphate n-hydrate, 12-tungstosilicate 26-hydrate, molybdenum chloride, 12-molybdophosphate n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, and bismuth nitrate.

Of these, the following compounds are particularly preferable: aluminum-containing compounds (for example, water-soluble aluminum compounds) such as aluminum sulfate, aluminum alum, aluminum sulfite, aluminum thiosulfate, aluminum nitrate nonahydrate, or aluminum chloride hexahydrate; and titanium-containing compounds such as titanium tetrachloride, tetraisopropyl titanate, titanium acetylacetonate, or titanium lactate.

Among them, the crosslinking agent to be used in the invention is particularly preferably a boron compound.

In the invention, the amount of the crosslinking agent is preferably from 5% by mass to 50% by mass, and more preferably from 8% by mass to 30% by mass, with respect to the water-soluble resin. When the amount of the crosslinking agent is within the above range, the water-soluble resin is efficiently crosslinked and the hardness of the resultant ink receiving layer is increased, whereby cracking and the like are prevented, and excellent scratch resistance can be obtained. Furthermore, change in secondary particle diameter of the inorganic fine particles between before and after ink application can be efficiently decreased, and, as a result, a high-quality recorded image which has a high print image density and reduced color change can be obtained.

The crosslinking agent may be used singly, or two or more thereof may be used in combination. The polyvalent metal compound is incorporated in an amount of preferably 0.1% by mass or more, more preferably 0.5% by mass or more, and particularly preferably 1.0% by mass or more, with respect to the water-soluble resin, from the viewpoints of performing a function as a preferable crosslinking agent, improving ozone resistance and glossiness, and ameliorating image bleeding. The upper limit of the amount of the polyvalent metal compound is preferably, but not particularly limited to, 50% by mass or less from the viewpoints of, for example, image density, ink absorbency, and inhibition of curling of a recording medium.

In the invention, the crosslinking agent may be incorporated into the ink receiving layer during formation of the ink receiving layer in any of the following manner: (i) the crosslinking agent may be added to the first coating liquid and/or to a coating liquid used for forming a layer adjacent to the ink receiving layer; (ii) a coating liquid containing the crosslinking agent is first applied onto a substrate, and the first coating liquid is then applied onto the substrate; or (iii) a first coating liquid that does not contains the crosslinking agent is applied onto a substrate and dried, and a second solution containing the crosslinking agent is applied thereto as an overcoat. From the viewpoint of production efficiency, it is preferable that the crosslinking agent is added to the first coating liquid or to a coating liquid used for forming a layer adjacent to the ink receiving layer such that the crosslinking agent is supplied to the ink receiving layer at the same time with the formation of the ink receiving layer. From the viewpoints of improving glossiness and print density of an image, the crosslinking agent is particularly preferably contained in the first coating liquid. The concentration of the crosslinking agent in the first coating liquid is preferably from 0.05% by mass to 10% by mass, and more preferably from 0.1% by mass to 7% by mass.

For example, the crosslinking agent may preferably be supplied as described below. In the following explanation, a boron compound is used as an example of the crosslinking agent. When the ink receiving layer is a layer obtained by crosslink-curing a coating layer formed by applying the first coating liquid, the crosslink-curing may be performed by adding a second solution containing an acidic compound to the coating layer either (1) at the same time with the formation of the coating layer formed by applying the first coating liquid or (2) during drying of the coating layer formed by applying the first coating liquid but before the coating layer shows falling-rate drying. The boron compound that serves as the crosslinking agent may be contained in any one of the first coating liquid or the second solution, or may be contained in both the first coating liquid and the second solution.

Additional Components

In addition to the above components, the first coating liquid of the invention may include other additives, as necessary, such as surfactants, mordants, ultraviolet absorbers, antioxidants, fluorescent whitening agents, monomers, polymerization initiators, polymerization inhibitors, bleeding inhibitors, antiseptics, viscosity stabilizers, defoaming agents, antistatic agents, mat agents, curling inhibitors, and water-resistant additives, such as those disclosed in paragraphs [0062] to [0079] of JP-A No. 2003-335043.

Surfactant

In the invention, the first coating liquid preferably includes a surfactant. The surfactant may be any of a cationic surfactant, an anionic surfactant, a nonionic surfactant, an amphoteric surfactant, a fluorine-containing surfactant, or a silicone surfactant.

Examples of the nonionic surfactant include polyoxyalkylene alkyl ethers and polyoxyalkylene alkyl phenyl ethers (such as diethylene glycol monoethyl ether, diethylene glycol diethyl ether, polyoxyethylene lauryl ether, polyoxyethylene stearyl ether, or polyoxyethylene nonyl phenyl ether), oxyethylene-oxypropylene block copolymers, sorbitan fatty acid esters (such as sorbitan monolaurate, sorbitan monooleate, or sorbitan trioleate), polyoxyethylene sorbitan fatty acid esters (such as polyoxyethylene sorbitan monolaurate, polyoxyethylene sorbitan monooleate, or polyoxyethylene sorbitan trioleate), polyoxyethylene sorbitol fatty acid esters (such as polyoxyethylene sorbitol tetraoleate), glycerin fatty acid esters (such as glycerol monooleate), polyoxyethylene glycerin fatty acid esters (such as polyoxyethylene glycerol monostearate or polyoxyethylene glycerol monooleate), polyoxyethylene fatty acid esters (such as polyethyleneglycol monolaurate or polyethyleneglycol monooleate), polyoxyethylene alkylamine, and acetylene glycols (such as 2,4,7,9-tetramethyl-5-decyne-4,7-diol, or an ethylene oxide adduct or propylene oxide adduct of the diol). Of these, polyoxyalkylene alkyl ethers are preferable. The nonionic surfactants may be incorporated into at least one of the first coating liquid or the second solution. The nonionic surfactant may be used singly, or in combination of two or more thereof.

Examples of the amphoteric surfactant include amino acid surfactants, carboxy ammonium betaine surfactants, sulfone ammonium betaine surfactants, ammonium sulfonic acid betaine surfactants, and imidazolium betaine surfactants, and the surfactants disclosed in U.S. Pat. No. 3,843,368, and JP-A Nos. 59-49535, 63-236546, 5-303205, 8-262742, and 10-282619 are preferably used. Of these, amino acid amphoteric surfactants are preferable, and examples thereof include surfactants derived from amino acids (such as glycine, glutamic acid, or histidine acid) such as those disclosed in JP-A 5-303205, and more specifically include N-aminoacyl acid having a long-chain acyl group introduced therein and salts thereof. The amphoteric surfactant may be used singly, or in combination of two or more thereof.

Examples of the anionic surfactant include fatty acid salts (such as sodium stearate or potassium oleate), alkyl sulfates (such as sodium lauryl sulfate or triethanolamine lauryl sulfate), sulfonates (such as sodium dodecyl benzene sulfonate), alkyl sulfosuccinates (such as sodium dioctyl sulfosuccinate), alkyldiphenyl ether disulfonate, and alkyl phosphates.

Examples of the cationic surfactant include alkyl amine salts, tertiary ammonium salts, pyridinium salts, and imidazolium salts.

Examples of the fluorine-containing surfactant include compounds derived via intermediates having a perfluoroalkyl group through a method such as electrolytic fluorination, telomerization, or oligomerization.

Specifically, examples thereof include perfluoroalkyl sulfonates, perfluoroalkyl carboxylates, perfluoroalkyl ethylene oxide adducts, perfluoroalkyl trialkyl ammonium salts, perfluoroalkyl group-containing oligomers, and perfluoroalkyl phosphates.

The silicone surfactant is preferably a silicone oil modified with an organic group, for example, a silicon oil in which a side chain of a siloxane structure is modified with an organic group, or a silicone oil in which both terminals of the siloxane structure are modified with organic groups, or a silicone oil in which one terminal of the siloxane structure is modified with an organic group. Examples of the modification with an organic group include amino modification, polyether modification, epoxy modification, carboxyl modification, carbinol modification, alkyl modification, aralkyl modification, phenol modification, and fluorine modification.

The amount of the surfactant to be used in the invention is preferably from 0.001% by mass to 2.0% by mass, and more preferably from 0.01% by mass to 1.0% by mass, with respect to the total amount of the first coating liquid.

Mordant

In the invention, the first coating liquid that forms an ink receiving layer may include at least one mordant in order to improve water resistance and to ameliorate bleeding over time of a formed image.

Examples of mordants include organic mordants such as cationic polymers (cationic mordants) and inorganic mordants. When the mordants are present in the ink receiving layer, the mordants interact with an ink liquid containing an anionic dye as an ink component, which results in stabilization of the ink liquid. As a result, water resistance can be improved, and bleeding over time can be ameliorated. In an embodiment, either an organic mordant or an inorganic mordant is used singly. In another embodiment, a combination of an organic mordant and an inorganic mordant is used.

Examples of the organic mordants include organic mordants disclosed in paragraphs to [0058] of JP-A No. 2003-335043.

The organic mordant that may be used in the invention is preferably a polyallylamine having a weight average molecular weight of 100,000 or less or a derivative thereof, especially from the viewpoint of inhibiting bleeding over time.

The inorganic mordant may be a water-soluble polyvalent metal salt, and specific examples thereof include inorganic mordants disclosed in paragraphs [0059] to [0060] of JP-A No. 2003-335043.

In the invention, the inorganic mordant may preferably be an aluminum-containing compound such as basic polyaluminum hydroxide or basic polyaluminum chloride, a titanium-containing compound, or a metal compound (salt or complex) of the Group IIIB metals in the periodical table of elements.

The amount of the mordant included in the ink receiving layer is preferably from 0.01 g/m² to 5 g/m², and more preferably from 0.1 g/m² to 3 g/m².

Second Solution

The second solution in the invention includes at least one acidic compound, and may include, as necessary, a solvent and additional components.

Acidic Compound

The acidic compound is not particularly limited, and may be an inorganic acid or an organic acid. In the invention, the acidic compound is preferably an acidic compound having a pKa of from 2 to 5 from the viewpoint of film strength of the ink receiving layer.

Specific examples of the acidic compound include inorganic acids such as hydrochloric acid, nitric acid, sulfuric acid, phosphoric acid, polyphosphoric acid, metaphosphoric acid, boric acid, boronic acid, sulfanilic acid, or sulfamic acid, and the basic polyaluminum chloride, which is described above as a mordant.

In the invention, the acidic compound may be used singly, or two or more thereof may be used in combination.

The amount of the acidic compound in the second solution in the invention is, but not particularly limited to, for example, from 0.001% by mass to 1% by mass, and more preferably from 0.005% by mass to 0.5% by mass, with respect to the total amount of the second solution.

Solvent

The second solution in the invention preferably includes at least one solvent. As the solvent used for the second solution, any of commonly-used solvents can be used without particular limitation. Examples of the solvent include water and organic solvents. The solvent preferably includes water and a hydrophilic organic solvent which is added thereto as necessary.

Additional Components

The second solution in the invention includes at least one acidic compound, and may further include, as necessary, additional components.

Examples of the additional components include the additional components that can be used in the first coating liquid.

Substrate

The substrate to be used in the invention may be a transparent substrate formed from a transparent material such as plastic, or an opaque substrate formed from an opaque material such as paper. From the viewpoint of taking advantage of transparency of an ink receiving layer, it is preferable to use a transparent substrate or high-gloss opaque substrate.

The material for the transparent substrate is preferably a transparent material that is resistant to radiant heat when used on an OHP or back light display. Examples of the material include polyesters such as polyethylene terephthalate (PET), polysulfone, polyphenylene oxide, polyimide, polycarbonate, and polyamide. Among them, polyesters are preferable, and polyethylene terephthalate is particularly preferable. The thickness of the transparent substrate is not particularly limited, but it is preferably from 50 μm to 200 μm in view of easy-handling.

The high-gloss opaque substrate preferably has a glossiness of 40% or more on the surface where the ink receiving layer is to be formed. The glossiness is a value determined by the method specified by JIS P-8142 (Testing Method for 75 Degree Specular Gloss of Paper and Paperboard), which is incorporated herein by reference. Specific examples of the substrate include those described in JP-A No. 2003-335043, paragraphs [0083] to [0094].

The substrate may have a backcoat layer provided thereon. Examples of components which can be added to the backcoat layer include white pigments, aqueous binders, and other components, such as those disclosed in paragraphs [0095] to [0096] of JP-A No. 2003-335043.

Method of Producing Inkjet Recording Medium

A first method of producing an inkjet recording medium according to the invention includes: preparing a first coating liquid by mixing an aqueous solution of an acetoacetyl-modified polyvinyl alcohol with a zirconium compound-containing liquid including inorganic fine particles and a zirconium compound (first coating liquid preparation process); and forming a coating layer (i.e., ink receiving layer) by applying the first coating liquid onto a substrate (coating layer formation process).

A second method of producing an inkjet recording medium according to the invention includes: preparing a first coating liquid by mixing an aqueous solution of an acetoacetyl-modified polyvinyl alcohol with a zirconium compound-containing liquid including inorganic fine particles and a zirconium compound (first coating liquid preparation process); forming a coating layer by applying the first coating liquid onto a substrate (coating layer formation process); and curing the coating layer (curing process) with crosslinking by applying a second solution containing an acidic compound (acidic compound-containing liquid) onto the coating layer either (1) at the same time with the application of the first coating liquid or (2) during drying of the coating layer formed by the application and before the coating layer shows falling-rate drying, whereby the coating layer is cured by crosslinking.

A third method of producing an inkjet recording medium according to the invention includes: preparing a first coating liquid by mixing an aqueous solution of an acetoacetyl-modified polyvinyl alcohol with a zirconium compound-containing liquid including inorganic fine particles and a zirconium compound; forming a coating layer (i.e., ink receiving layer) by applying the first coating liquid onto a substrate; and, after cooling of the coating layer, drying the coating layer using dry air having a dew-point temperature that is at least 10° C. lower than the temperature of the cooled coating layer.

In the invention, a hybrid of the second method and the third method is also preferable.

According to the first, second, or third methods or a hybrid thereof, the first coating liquid which has excellent stability over time can be obtained, and an inkjet recording medium having an ink receiving layer having low brittleness can also be obtained using the first coating liquid.

The method of producing an inkjet recording medium of the invention may further include, in addition to the above processes, other processes as necessary.

First Coating Liquid Preparation Process

The first to third methods of producing an inkjet recording medium according to the invention each include the first coating liquid formation process (hereinafter, also referred to as “preparation process”), in which the first coating liquid is prepared by mixing the aqueous solution of an acetoacetyl-modified polyvinyl alcohol with the zirconium compound-containing liquid. When mixing the aqueous solution of an acetoacetyl-modified polyvinyl alcohol with the zirconium compound-containing liquid in each of the above processes, the aqueous solution of an acetoacetyl-modified polyvinyl alcohol may be added to the zirconium compound-containing liquid.

When the preparation of the first coating liquid is performed in a mixing order in which the aqueous solution of an acetoacetyl-modified polyvinyl alcohol is added to the zirconium compound-containing liquid, change in physical properties (such as viscosity) of the coating liquid is small, as a result of which the obtained first coating liquid has excellent stability over time.

The preparation of the first coating liquid is not particularly limited as long as the aqueous solution of an acetoacetyl-modified polyvinyl alcohol is added to the zirconium compound-containing liquid, but may be performed as follows, for example.

Preparation Method 1

(1) An aqueous solution of a zirconium compound is added to an inorganic fine particle pre-dispersion liquid while dispersing and mixing, thereby preparing a zirconium compound-containing liquid (preparation of a zirconium compound-containing liquid).

In this process, the inorganic fine particle pre-dispersion liquid is prepared by dispersing and mixing inorganic fine particles into water or the like.

(2) Next, an aqueous solution of an acetoacetyl-modified polyvinyl alcohol is added to the zirconium compound-containing liquid, which is obtained by the process (1), while dispersing and mixing, thereby preparing the first coating liquid (preparation of the first coating liquid).

In the process (2), an additional component such as a surfactant may be added, as necessary, together with the aqueous solution of an acetoacetyl-modified polyvinyl alcohol.

Preparation Method 2

(1) Inorganic fine particles and a zirconium compound are dispersed and mixed into water, thereby preparing an inorganic fine particle dispersion liquid (preparation of a zirconium compound-containing liquid).

(2) Next, an aqueous solution of an acetoacetyl-modified polyvinyl alcohol is added to the zirconium compound-containing liquid, which is obtained by the process (1), while dispersing and mixing, thereby preparing the first coating liquid (preparation of the first coating liquid).

In the process (1) of the preparation method 2, an additional component such as a dispersant may be added as necessary.

In the process (2) of the preparation method 2, an additional component such as a surfactant may be added as necessary, together with the aqueous solution of an acetoacetyl-modified polyvinyl alcohol.

The first coating liquid in the invention (hereinafter, may also referred to as “coating liquid for ink receiving layer formation”) may be prepared, for example, as described below.

Inorganic fine particles such as vapor-phase process silica and a dispersant are added to water (the amount of the silica fine particles in water is, for example, from 10% by mass to 20% by mass) and dispersed using a high-speed rotary wet colloid mill (for example, CLEAMIX (trade name) manufactured by M Technique Co., Ltd.) at a high-speed rotation of, for example, 10,000 rpm (or preferably from 5,000 rpm to 20,000 rpm) for, for example, 20 minutes (or preferably from 10 minutes to 30 minutes). After that, a zirconium compound is added thereto, and dispersed under the same rotation conditions as above.

Subsequently, an aqueous solution of an acetoacetyl-modified polyvinyl alcohol (and other water-soluble resins, if any) is added to the resultant solution in such a manner that, for example, the total mass of water-soluble resins is about one-third of the mass of the vapor-phase process silica, whereby the first coating liquid is obtained.

The thus-obtained coating liquid is a uniform sol. When the coating liquid is applied onto a substrate by the following coating method and dried, a porous ink receiving layer having a three-dimensional network structure is formed.

The water dispersion containing the inorganic fine particles and the dispersant may be prepared by (i) preparing a water dispersion of inorganic fine particles in advance, and adding the water dispersion to a dispersant aqueous solution, or (ii) adding a dispersant aqueous solution to the water dispersion of inorganic fine particles, or (iii) mixing a dispersant aqueous solution and the water dispersion of inorganic fine particles at one time. Alternatively, instead of the water dispersion of inorganic fine particles, powdery inorganic fine particles may be added to the dispersant aqueous solution in the same manner as described above.

After mixing of the inorganic fine particles and the dispersant, the resultant mixture liquid may be treated with a dispersion apparatus so as to decrease the particle size, whereby a water dispersion of inorganic fine particles having an average particle diameter of from 50 nm to 300 nm may be obtained.

Examples of the dispersion apparatus which can be used for obtaining the water dispersion include various conventionally-known dispersers such as a high-speed rotating disperser, a media agitation disperser (such as a ball mill or sand mill), an ultrasonic disperser, a colloid mill disperser, or a high-pressure disperser. From the viewpoint of efficiently disintegrating an aggregate of fine particles which may occur, it is preferable to use a media agitation disperser, a colloid mill disperser, or a high-pressure disperser.

In the invention, any of the dispersion apparatuses and the like may be used also for the preparation of the first coating liquid and the second solution.

Solvents used in the respective processes may be selected from water, an organic solvent, or a mixed solvent thereof. Examples of organic solvents which may be used for the coating include alcohols such as methanol, ethanol, n-propanol, i-propanol, or methoxy propanol, ketones such as acetone or methyl ethyl ketone, tetrahydrofuran, acetonitrile, ethyl acetate, and toluene.

The dispersant may be a cationic polymer. Examples of the cationic polymer include the cationic polymers that are described as examples of the mordants in the above. Further examples of the dispersant include a silane coupling agent.

The amount of the dispersant to be added is preferably from 0.1% by mass to 30% by mass, and more preferably from 1% by mass to 10% by mass, with respect to the inorganic fine particles.

To each of the zirconium compound-containing liquid and the aqueous solution of an acetoacetyl-modified polyvinyl alcohol, at least one of a pH adjuster, a dispersant, a surfactant, a defoaming agent, an antistatic agent, or the like may be added as necessary.

Coating Layer Formation Process

The first to third methods of producing an inkjet recording medium according to the invention each include forming a coating layer by applying the first coating liquid onto a substrate (hereinafter, also referred to as a coating layer formation process).

In the coating layer formation process, the first coating liquid is applied onto a substrate, and one or more other coating liquids may be applied onto the first coating liquid, as necessary.

The coating method for the first coating liquid (and the other optional coating liquids) is not particularly limited, and any known coating apparatus such as an extrusion die coater, an air doctor coater, a blade coater, a rod coater, a knife coater, a squeeze coater, a reverse roll coater, or a bar coater may be used.

The wet coating amount of the first coating liquid is preferably from 50 ml/m² to 200 ml/m², and more preferably from 75 ml/m² to 150 ml/m². The coating amount of the first coating liquid in terms of solid content is preferably from 5 g/m² to 25 g/m², and more preferably from 10 g/m² to 18 g/m².

Cooling and Drying Process

The third method further includes cooling the coating layer that has been formed in the coating layer formation process, and drying the coating layer using dry air having a dew-point temperature that is at least 10° C. lower than the temperature of the cooled coating layer (hereinafter sometimes referred to as a drying process).

The cooling of the coating layer is preferably carried out by cooling the substrate on which the coating layer has been formed in a cooling zone maintained at a temperature of from 0° C. to 10° C. for from 5 seconds to 30 seconds, such that the temperature of the cooled coating layer is from 0° C. to 20° C.

The temperature of the coating layer is determined by measuring the temperature of the layer surface.

Curing Process

The second method includes curing the coating layer formed in the coating layer formation process with crosslinking of the coating layer by applying a solution (second solution) containing an acidic compound onto the coating layer either (1) at the same time with the application of the first coating liquid or (2) during drying of the coating layer formed by the application of the first coating liquid but before the coating layer shows falling-rate drying (hereinafter, also referred to as a curing process). The second solution may have a pH of, for example, 6 or less.

Application of the acidic compound-containing liquid (1) at the same time with the application of the first coating liquid is preferably carried out by simultaneously coating (multilayer-coating) the first coating liquid (and the additional coating liquid, if necessary) and the acidic compound-containing liquid in this order from the substrate side. The simultaneous coating (multilayer-coating) may be performed with a known coating apparatus, such as an extrusion die coater or a curtain flow coater.

A preferable method of applying the acidic compound-containing liquid (2) during drying of the coating layer formed by the application of the first coating liquid but before the coating layer shows falling-rate drying is the method referred to as “Wet-On-Wet method” or “WOW method.” Details of the “Wet-On-Wet method” are described in, for example, JP-A No. 2005-14593, paragraphs [0016] to [0037].

In the invention, a coating layer may be formed by applying the first coating liquid onto a substrate. Alternatively, a coating layer may be formed by simultaneously coating (simultaneous multilayer-coating), or separately coating layer by layer, the first coating liquid and one or more additional coating liquids in this order from the substrate side. In any case, after the formation of the coating layer, an acidic compound-containing liquid may be applied to the coating layer during drying of the coating layer thus formed but before the coating layer shows falling-rate drying, by (i) a method of further coating the acidic compound-containing liquid on the thus-formed coating layer, (ii) a method of spraying the acidic compound-containing liquid onto the thus-formed coating layer, or (iii) a method of immersing the substrate having the coating layer in the acidic compound-containing liquid.

Methods that may be used for applying the acidic compound-containing liquid in the method (i) include methods known in the art such as using a curtain flow coater, an extrusion die coater, an air doctor coater, a blade coater, a rod coater, a knife coater, a squeeze coater, a reverse roll coater and a bar coater. It is preferable to employ a method in which the coater does not directly contact an already-formed coating layer, such as a method of using an extrusion die coater, a curtain flow coater, or a bar coater.

The expression “before the coating layer shows falling-rate drying” usually refers to a period of several minutes from immediately after the application of the first coating liquid (and, optionally, one or more additional coating liquids), and, in this period, the applied coating layer shows the phenomenon of “constant-rate drying” whereby the solvent (dispersion medium) content in the coating layer decreases in proportion to a lapse of time. With respect to the period during which the constant-rate drying is observed, Kagaku Kogaku Binran (Handbook of Chemical Technology), pages 707-712, MARUZEN Co., Ltd. (Oct. 25, 1980) may be referenced, for example.

Drying until the coating layer begins to show falling-rate drying may be performed at 40° C. to 180° C. for 0.5 minutes to 10 minutes (preferably 0.5 minutes to 5 minutes). Although the drying time naturally varies with the coating amount, the range specified above is usually appropriate.

Additional Process

In the first, second, and third methods, the ink receiving layer that has been formed on the substrate may be calendered by, for example, passing the substrate having the ink receiving layer through a nip between rolls under heat and pressure using a super calender, a gloss calender, or the like, whereby surface smoothness, glossiness, transparency, and film strength can be improved. However, the calender treatment sometimes decreases porosity of the ink receiving layer (which results in decrease in ink absorbency). Therefore, the calender treatment should be performed under conditions that cause less decrease in porosity of the ink receiving layer.

The roll temperature in the calender treatment is preferably from 30° C. to 150° C., and more preferably from 40° C. to 100° C.

The linear pressure applied between the rollers in the calender treatment is preferably from 50 kg/cm to 400 kg/cm, and more preferably from 100 kg/cm to 200 kg/cm.

In a case of inkjet recording, the thickness of the ink receiving layer is preferably determined in relation to the porosity of the ink receiving layer because the ink receiving layer should have an absorption capacity capable of absorbing all ink droplets received on the ink receiving layer. For example, when the amount of ink is 8 nL/mm² and the porosity of the ink receiving layer is 60%, the thickness of the ink receiving layer should be about 15 μm or more.

In view of the above, the ink receiving layer for use in inkjet recording preferably has a thickness of from 10 μm to 50 μm.

The ink receiving layer has an average pore diameter of preferably from 0.005 μm to 0.025 μm, and more preferably from 0.01 μm to 0.025 μm.

The porosity and pore median diameter may be determined using a mercury porosimeter (e.g., PORESIZER 9320-PC2 (trade name) manufactured by Shimadzu Corporation).

The ink receiving layer preferably has excellent transparency. For example, when the ink receiving layer is formed on a transparent film substrate, the haze value is preferably 30% or less, and more preferably 20% or less.

The haze value may be determined using a hazemeter (e.g., HGM-2DP (trade name) manufactured by Suga Test Instruments Co., Ltd.).

A polymer fine-particle dispersion may be incorporated into any of the constituent layers (for example, the ink receiving layer or a back layer) of the inkjet recording medium obtained by the method of the invention. This polymer fine-particle dispersion is used for the purpose of improving film physical properties, such as dimensional stability and anti-curling, anti-sticking and anti-cracking properties. Descriptions of the polymer fine-particle dispersion can be found in, for example, JP-A Nos. 62-245258 and 62-1316648, and 62-110066. When a dispersion of polymer fine particles with a low glass transition temperature (40° C. or lower) is incorporated into the above-described layer containing a mordant, cracking and curling of the layer may be prevented. Alternatively, curling may be prevented also by adding a dispersion of polymer fine particles with a high glass transition temperature to a back layer.

### EXAMPLES

In the following, the present invention is described in further detail with reference to examples. However, the examples should not be construed as limiting the present invention. The terms “part” and “%” refer to “part by mass” and “% by mass”, respectively, unless indicated otherwise.

### Example 1

### Preparation of Coating Liquid 1

The following components (1) to (5) were added in the following order while stirring with a homomixer, whereby a coating liquid 1 was prepared.

### Composition of Coating Liquid 1

| | |
|---|---|
| (1) Alumina sol (average particle diameter: 0.07 μm; solid | 62.6 parts |
| content: 20%) | |
| (2) ZrO(OH)Cl (zirconyl hydroxy chloride; solid content: | 0.84 parts |
| 30%) | |
| (3) 10% Aqueous solution of acetoacetyl-modified polyvinyl | 31.3 parts |
| alcohol (GOHSEFIMER Z-200 (registered trademark) | |
| manufactured by Nippon Synthetic Chemical Industry Co., | |
| Ltd.) | |
| (4) Polyoxyethylene alkyl phenol surfactant | 0.13 parts |
| (5) Water | 5.2 parts |

Production of Inkjet Recording Medium

The thus-prepared coating liquid 1 was applied onto a polyethylene terephthalate film (substrate 1) having a thickness of 100 μm using an extrusion-hopper curtain coating apparatus in such a manner that a curtain film was formed at a discharge rate of 7,500 ml/min. per 1 m of the curtain film width and at a coating speed of 30 m/min. The resultant coating film was cooled by blowing air having a temperature of 5° C., and then dried by blowing dry air having a temperature of 20° C. and a dew-point temperature of −5° C., whereby an inkjet recording medium was obtained.

### Example 2

### Preparation of Substrate

A wood pulp formed of 100 parts of leaf bleached kraft pulp (LBKP) was beaten to a Canadian Standard Freeness of 300 ml using a double disk refiner. Then, 0.5 parts of epoxidized behenamide, 1.0 part of anionic polyacrylamide, 0.1 parts of polyamide-polyamine-epichlorohydrin, and 0.5 parts of cationic polyacrylamide, respectively in absolute dry mass ratios with respect to the pulp, were added thereto. The resultant mixture was processed into paper using a fourdrinier paper machine to obtain base paper having a basis weight of 170 g/m².

To adjust the surface size of the base paper, 0.04% of a fluorescent whitening agent (WHITEX BB (trade name), manufactured by Sumitomo Chemical Co., Ltd.) was added to a 4% aqueous solution of polyvinyl alcohol, and then the base paper was impregnated with the resultant solution such that the amount of the fluorescent whitening agent was 0.5 g/m² in terms of absolute dry weight, followed by drying. Thereafter, the base paper was further subjected to a calender treatment to obtain base paper having a density adjusted to 1.05 g/cm³.

The wire surface (i.e., rear surface) of the thus-obtained base paper was subjected to a corona discharge treatment, and then coated with a 19 μm-thick high-density polyethylene using a melt extruder, whereby a resin layer having a mat surface was formed. Hereinafter, the resin layer surface is referred to as “rear surface”. The rear resin layer was further subjected a corona discharge treatment, and coated with a dispersion liquid obtained by dispersing aluminum oxide (ALUMINASOL 100 (trade name) manufactured by Nissan Chemical Industries, Ltd.) and silicon dioxide (SNOWTEX O (registered trademark) manufactured by Nissan Chemical Industries, Ltd.) as antistatic agents in a mass ratio (aluminum oxide:silicon dioxide) of 1:2 in water, such that dry coating weight of the dispersion liquid was 0.2 g/m².

The felt surface (i.e., front surface) of the base paper on which the resin layer was not provided was subjected to a corona discharge treatment. Then, a low-density polyethylene which had a melt flow rate (MFR) of 3.8 and contained 10% of anatase titanium dioxide, a minute amount of ultramarine, and 0.01% of a fluorescent whitening agent, the percentages being relative to the mass of the polyethylene, was melt-extruded using a melt extruder, to form a high-gloss thermoplastic resin layer having a thickness of 29 μm on the front surface of the base paper (hereinafter, the high-gloss surface is referred to as “front surface”), whereby a resin-coated paper was obtained. The resin-coated paper was used as a substrate 2.

Preparation of Coating Liquid 2

The following components (1) to (4) were added in the following order while stirring with a homomixer, whereby a coating liquid 2 was prepared. The coating liquid 2 had a pH of 3.8.

### Composition of Coating Liquid 2

| | |
|---|---|
| (1) Vapor-phase process silica dispersion liquid 1 (see below) | 65.0 parts |
| (2) 10% Aqueous solution of acetoacetyl-modified polyvinyl | 20.0 parts |
| alcohol (GOHSEFIMER Z-200 (registered trademark) | |
| manufactured by Nippon Synthetic Chemical Industry Co., | |
| Ltd.) | |
| (3) Polyoxyethylene lauryl ether (surfactant; 10% aqueous | 0.8 parts |
| solution of EMULGEN 109P (trade name), manufactured | |
| by Kao Corporation) | |
| (4) Water | 8.0 parts |

Preparation of Vapor-Phase Process Silica Dispersion Liquid 1

(1) vapor-phase process silica fine particles, (2) ion-exchange water, (3) SHALLOL DC-902P, and (4) ZA-30 as descried below were mixed and dispersed using a liquid-liquid collision disperser (ULTIMIZER (trade name), manufactured by Sugino Machine Ltd.). The resultant dispersion liquid (i.e., zirconium compound-containing liquid) was heated to 45° C. and maintained at that temperature for 20 hours.

Composition of Vapor-Phase Process Silica Dispersion Liquid 1

| | |
|---|---|
| (1) Vapor-phase silica fine particles (inorganic fine | 8.9 parts |
| particles; AEROSIL (registered trademark) 300SF75, | |
| manufactured by Nippon Aerosil Co., Ltd.) | |
| (2) Ion-exchange water | 54.8 parts |
| (3) SHALLOL DC-902P (51.5% aqueous solution) | 0.8 parts |
| (dispersant; nitrogen-containing cationic polymer, | |
| manufactured by Dai-ichi Kogyo Seiyaku Co., Ltd.) | |
| (4) ZIRCOSOL ZA-30 (trade name, manufactured by | 0.5 parts |
| Daiichi Kigenso Kagaku Kogyo Co., Ltd.; zirconyl acetate) | |

Production of Inkjet Recording Medium

### Formation of Ink Receiving Layer

The front surface of the substrate 2 was subjected to a corona discharge treatment. Then, the coating liquid 2 and the following in-line liquid were subjected to in-line mixing, and the resultant coating solution at 38° C. was applied onto the front surface of the substrate 2 using an extrusion die coater, thereby forming a coating layer. Here, the in-line mixing was performed at a rate such that the coating amount of the coating liquid 2 was 196 g/m² and the coating amount of the in-line liquid was 16.5 g/m².

Composition of in-Line Liquid

| | |
|---|---|
| (1) ALFINE 83 (trade name, manufactured by Taimei | 2.0 parts |
| Chemicals Co., Ltd.; 26.0% aqueous solution; acidic | |
| compound) | |
| (2) Ion-exchange water | 7.8 parts |
| (3) HYMAX SC-507 (trade name, manufactured by Hymo | 0.2 parts |
| Co., Ltd.; dimethylamine/epichlorohydrin polycondensate; | |
| 70% aqueous solution) | |

The coating layer formed as described above was dried using a hot air drier at 80° C. (at a wind speed of from 3 m/sec. to 8 m/sec.) until the solid content of the coating layer became 24%. The coating layer was further dried at 72° C. for 10 minutes to form an ink receiving layer on the substrate.

An inkjet recording medium was formed in the manner described above.

### Example 3

### Production of Inkjet Recording Medium

### Formation of Ink Receiving Layer

The front surface of the substrate 2 was subjected to a corona discharge treatment, and then a coating layer was formed thereon by applying 196 g/m² of the coating liquid 2 at a coating liquid temperature of 38° C. using an extrusion die coater.

The coating layer formed as described above was dried using a hot air drier at 80° C. (at a wind speed of from 3 m/sec. to 8 m/sec.) until the solid content concentration of the coating layer became 24%. During this process, the drying rate of the coating layer was constant (the coating layer showed the phenomenon of “constant-rate drying.”).

Immediately after the drying, the coated substrate was immersed into a solution containing an acidic compound, the composition of which is shown below, for 3 seconds to allow 13 g/m² of the solution to adhere onto the coating layer, and the adhered solution was dried at 72° C. for 10 minutes (drying process), whereby an ink receiving layer was formed on the substrate.

An inkjet recording medium was formed in the manner described above.

Composition of Solution Containing Acidic Compound

| | |
|---|---|
| (1) Ion-exchange water | 74.0 parts |
| (2) ALFINE 83 (trade name, manufactured by Taimei | 20.0 parts |
| Chemicals Co., Ltd.; 26.0% aqueous solution; acidic | |
| compound) | |
| (3) Polyoxyethylene lauryl ether (surfactant; 10% aqueous | 6.0 parts |
| solution of EMULGEN 109P (trade name), manufactured | |
| by Kao Corporation) | |

### Example 4

### Preparation of Coating Liquid 3

The following components (1) to (5) were added in the following order while stirring with a homomixer, whereby a coating liquid 3 was prepared.

### Composition of Coating Liquid 3

| | |
|---|---|
| (1) Vapor-phase silica dispersion liquid 1 described above | 65.0 parts |
| (2) 10% Aqueous solution of acetoacetyl-modified | 20.0 parts |
| polyvinyl alcohol (GOHSEFIMER Z-200 (registered | |
| trademark) manufactured by Nippon Synthetic | |
| Chemical Industry Co., Ltd.) | |
| (3) Polyoxyethylene lauryl ether (surfactant; 10% aqueous | 0.8 parts |
| solution of EMULGEN 109P (trade name), manufactured | |
| by Kao Corporation) | |
| (4) Ammonium carbonate (first grade, manufactured by | 0.5 parts |
| Kanto Chemical Co., Inc.) | |
| (5) Water | 8.0 parts |

Production of Inkjet Recording Medium

An ink receiving layer was formed and an inkjet recording medium was produced, in the same manner as the formation of the ink receiving layer of Example 3 except that the coating liquid 2 was replaced by the coating liquid 3.

### Comparative Example 1

### Preparation of Coating Liquid 11

The following components (1) to (5) were added in the following order while stirring with a homomixer, whereby a coating liquid 11 was prepared.

### Composition of Coating Liquid 11

| | |
|---|---|
| (1) Alumina sol (average particle diameter: 0.07 μm; solid | 62.6 parts |
| content: 20%) | |
| (2) 10% Aqueous solution of acetoacetyl-modified | 31.3 parts |
| polyvinyl alcohol (GOHSEFIMER Z-200 (registered | |
| trademark) manufactured by Nippon Synthetic Chemical | |
| Industry Co., Ltd.) | |
| (3) ZrO(OH)Cl (zirconyl hydroxy chloride; solid content: | 0.84 parts |
| 30%) | |
| (4) Polyoxyethylene alkyl phenol surfactant | 0.13 parts |
| (5) Water | 5.2 parts |

Production of Inkjet Recording Medium

An ink receiving layer was formed and an inkjet recording medium was produced, in the same manner as the formation of the ink receiving layer of Example 1 except that the coating liquid 1 was replaced by the coating liquid 11.

### Example 5

A coating liquid 4 was prepared and an inkjet recording medium was produced, in the same manner as the preparation of the coating liquid 2 except for changing the zirconyl acetate to zirconyl nitrate. An ink receiving layer was formed in the same manner as in Example 3 except that the coating liquid 4 was used instead of the coating liquid 2.

### Example 6

A coating liquid 5 was prepared and an inkjet recording medium was produced, by adjusting the pH of the (1) vapor-phase process silica dispersion liquid 1 to pH 5 by adding ammonium carbonate, and thereafter, similarly to the preparation of the coating liquid 2, adding the (2) 10% aqueous solution of an acetoacetyl-modified polyvinyl alcohol, the (3) polyoxyethylene lauryl ether and the (4) water. An ink receiving layer was formed in the same manner as in Example 3 except that the coating liquid 5 was used instead of the coating liquid 3.

### Example 7

A coating liquid 6 was prepared and an inkjet recording medium was produced, by adjusting the pH of the (1) vapor-phase process silica dispersion liquid 1 to pH 5.5 by adding ammonia water, and thereafter, similarly to the preparation of the coating liquid 2, adding the (2) 10% aqueous solution of an acetoacetyl-modified polyvinyl alcohol, the (3) polyoxyethylene lauryl ether and the (4) water. An ink receiving layer was formed in the same manner as in Example 3 except that the coating liquid 6 was used instead of the coating liquid 2.

### Example 8

A coating liquid 7 was prepared and an inkjet recording medium was produced, in the same manner as the preparation of the coating liquid 2 except for changing the zirconyl acetate to zirconyl chloride. An ink receiving layer was formed in the same manner as in Example 3 except that the coating liquid 7 was used instead of the coating liquid 2.

### Example 9

A coating liquid 8 was prepared and an inkjet recording medium was produced, in the same manner as the preparation of the coating liquid 2 except for changing the zirconyl acetate to ammonium zirconyl carbonate. An ink receiving layer was formed in the same manner as in Example 3 except that the coating liquid 8 was used instead of the coating liquid 2.

### Comparative Example 2

An ink receiving layer was formed and an inkjet recording medium was produced, in the same manner as in Example 2, except that the 10% aqueous solution of acetoacetyl-modified polyvinyl alcohol used in the preparation of the coating liquid 2 was replaced by JM33 (tradename, manufactured by JAPAN VAM & POVAL CO., LTD.; polyvinyl alcohol (PVA) having a saponification degree of 95.5% and a polymerization degree of 3,300).

However, since the obtained coating film was weak, evaluation could not be performed.

Evaluation

The resultant inkjet recording media were evaluated as described below. The results are shown in Table 1.

1. Stability of Coating Liquid

The coating liquids 1 to 8, 10 and 11 were left stand at 30° C., so that the viscosity thereof was allowed to increase with time. Each coating liquid was evaluated in accordance with the following criteria based on the time it takes for the viscosity of the coating liquid to reach 300 mPa·s or more.

The viscosity was determined at 30° C. using a B viscometer (manufactured by Tokyo Keiki Inc.) in accordance with a conventional method of determining viscosity of a liquid (JIS Z8803 which is incorporated herein by reference). The viscosity is represented by the unit “mPa·s.”

### Criteria

A: Even when the coating liquid for an ink receiving layer was left to stand overnight after the preparation of the coating liquid, there was no difficulty in the usage thereof.
B: There was no difficulty in the usage of the coating liquid for an ink receiving layer within an hour after the preparation of the coating liquid.
C: There was slight difficulty in the usage of the coating liquid for an ink receiving layer except for immediately after the preparation of the coating liquid.
D: The coating liquid exhibited rapid and remarkable increase in viscosity, and could not be used.

2. Brittleness

The inkjet recording medium was stored for a day in a constant temperature and humidity room at a temperature of 10° C. and a relative humidity of 20%. Thereafter, the inkjet recording medium was wound around a cylinder to evaluate brittleness thereof. When the diameter of the cylinder is smaller, the ink receiving layer is more likely to crack. The limit (mm) of the diameter of the cylinder at which a crack was generated was regarded as an index of brittleness.

### Criteria

A: The limit was less than 30 mm, which means a good brittleness level.
B: The limit was in the range from 30 mm to 40 mm, which means an acceptable brittleness level.
C: The limit was more than 40 mm, which means an unacceptable brittleness level.

TABLE 1

| | | | | | Addition- | | | Evaluation | |
|---|---|---|---|---|---|---|---|---|---|
| | Zirconium compound- | | | | method of | | | Temporal | |
| | containing liquid | | | Condition of | acidic | | | stability | |
| | Zirconium | pH | | preparation of | compound | Coating | | of coating | Brit- |
| | compound | adjuster | PVA | coating liquid | solution | liquid | Drying | liquid | tleness |
| Example 1 | Zirconyl hydroxy | — | acetoacetyl- | Zr compound was | None | Coating | Cool | A | A |
| | chloride | | modified | added in advance. | | liquid 1 | drying | | |
| Example 2 | Zirconyl acetate | — | acetoacetyl- | Zr compound was | In-line | Coating | Hot air | B | A |
| | | | modified | added in advance. | addition | liquid 2 | drying | | |
| Example 3 | Zirconyl acetate | — | acetoacetyl- | Zr compound was | Immersion | Coating | Hot air | B | A |
| | | | modified | added in advance. | | liquid 2 | drying | | |
| Example 4 | Zirconyl acetate | — | acetoacetyl- | Zr compound was | Immersion | Coating | Hot air | A | A |
| | | | modified | added in advance. | | liquid 3 | drying | | |
| Example 5 | Zirconyl nitrate | — | acetoacetyl- | Zr compound was | Immersion | Coating | Hot air | B | A |
| | | | modified | added in advance. | | liquid 4 | drying | | |
| Example 6 | Zirconyl acetate | Ammonium | acetoacetyl- | Zr compound was | Immersion | Coating | Hot air | A | A |
| | | carbonate | modified | added in advance. | | liquid 5 | drying | | |
| Example 7 | Zirconyl acetate | Ammonia | acetoacetyl- | Zr compound was | Immersion | Coating | Hot air | A | A |
| | | | modified | added in advance. | | liquid 6 | drying | | |
| Example 8 | Zirconyl chloride | — | acetoacetyl- | Zr compound was | Immersion | Coating | Hot air | B | A |
| | | | modified | added in advance. | | liquid 7 | drying | | |
| Example 9 | Ammonium zirconyl | — | acetoacetyl- | Zr compound was | Immersion | Coating | Hot air | A | A |
| | carbonate | | modified | added in advance. | | liquid 8 | drying | | |
| Comparative | Zirconyl hydroxy | — | acetoacetyl- | Zr compound was | None | Coating | Cool | D | C |
| Example 1 | chloride | | modified | added afterwards. | | liquid 11 | drying | | |
| Comparative | Zirconyl acetate | — | unmodified | Zr compound was | In-line | Coating | Hot air | A | Evaluation |
| Example 2 | | | | added in advance. | addition | liquid 10 | drying | | Impossible |

As shown in Table 1, the coating liquids prepared by the production method of invention had excellent stability over time, and brittleness of the inkjet recording media obtained using the coating liquids were excellent.

### Examples 10 to 15

Ink receiving layers of Examples 10 to 15 were formed and inkjet recording media of Examples 10 to 15 were produced, in the same manner as in Examples 2 to 7, respectively, except that the heat treatment (at 45° C. for 20 hours) conducted in the preparation of the vapor-phase silica dispersion liquid 1 used in the preparation of each of the coating liquids was not conducted. Evaluations were conducted in the same manner as in Examples 1 to 7. The evaluation results are shown in Table 2 below.

TABLE 2

| | | | Addition- | Evaluation | |
|---|---|---|---|---|---|
| | Zirconium compound- | | method of | Temporal | |
| | containing liquid | | acidic | stability | |
| | Zirconium | pH | compound | of coating | Brit- |
| | compound | adjuster | solution | liquid | tleness |
| Example 10 | Zirconyl | — | In-line | C | A |
| | acetate | | addition | | |
| Example 11 | Zirconyl | — | Immersion | C | A |
| | acetate | | | | |
| Example 12 | Zirconyl | — | Immersion | B | A |
| | acetate | | | | |
| Example 13 | Zirconyl | — | Immersion | C | A |
| | nitrate | | | | |
| Example 14 | Zirconyl | Ammonium | Immersion | B | A |
| | acetate | carbonate | | | |
| Example 15 | Zirconyl | Ammonia | Immersion | B | A |
| | acetate | | | | |

As shown in Table 2 above, in Examples 10 to 15, results similar to Examples 1 to 9 were obtained even when a heat treatment was not conducted on the vapor-phase silica dispersion liquid before the vapor-phase silica dispersion liquid was mixed with the acetoacetyl-modified polyvinyl alcohol.

According to the invention, a method of producing an inkjet recording medium is provided. A coating liquid prepared in the method has excellent temporal stability, and an ink receiving layer having low brittleness can be formed, according to the method.

Embodiments of the present invention include, but are not limited to, the following.

<1> A method of producing an inkjet recording medium, the method comprising: preparing a first coating liquid by mixing an aqueous solution of an acetoacetyl-modified polyvinyl alcohol with a zirconium compound-containing liquid comprising inorganic fine particles and a zirconium compound; and forming a coating layer by applying the first coating liquid onto a substrate.
<2> The method of producing an inkjet recording medium according to <1>, wherein preparing the first coating liquid includes adjusting the pH of the zirconium compound-containing liquid to a value of from 4.5 to 6.
<3> The method of producing an inkjet recording medium according to <1> or <2>, further comprising curing the coating layer with crosslinking by applying thereto a second solution comprising an acidic compound either (1) at the same time as the application of the first coating liquid or (2) during drying of the coating layer formed by the application of the first coating liquid but before the coating layer shows falling-rate drying.
<4> The method of producing an inkjet recording medium according to any one of <1> to <3>, further comprising, after the formation of the coating layer, cooling the coating layer and drying the cooled coating layer with dry air having a dew-point temperature that is at least 10° C. lower than the temperature of the cooled coating layer.
<5> The method of producing an inkjet recording medium according to any one of <1> to <4>, wherein the zirconium compound comprises at least one selected from the group consisting of zirconyl hydroxy chloride, zirconyl chloride, zirconyl nitrate, zirconyl acetate, and ammonium zirconyl carbonate.
<6> The method of producing an inkjet recording medium according to any one of <2> to <5>, wherein preparing the first coating liquid includes adjusting the pH of the zirconium compound-containing liquid by using ammonia or an ammonium compound.
<7> The method of producing an inkjet recording medium according to any one of <1> to <6>, wherein the inorganic fine particles comprise at least one selected from silica fine particles, colloidal silica, alumina fine particles, or pseudoboehmite fine particles.
<8> The method of producing an inkjet recording medium according to any one of <1> to <7>, wherein the degree of acetoacetyl modification of the acetoacetyl-modified polyvinyl alcohol is from 0.1 to 20 mol %.
<9> The method of producing an inkjet recording medium according to any one of <1> to <8>, wherein the first coating liquid further comprises a water-soluble resin other than the acetoacetyl-modified polyvinyl alcohol.
<10> The method of producing an inkjet recording medium according to any one of <1> to <9>, wherein, in the first coating liquid, a ratio (PB ratio (x/y)) of the total mass (x) of the inorganic fine particles to the total mass (y) of water-soluble resins including the acetoacetyl-modified polyvinyl alcohol is from 1.5 to 10.
<11> The method of producing an inkjet recording medium according to any one of <1> to <10>, wherein the first coating liquid further comprises a crosslinking agent that is capable of crosslinking the acetoacetyl-modified polyvinyl alcohol.
<12> The method of producing an inkjet recording medium according to <11>, wherein the crosslinking agent is at least one selected from borax, boric acid, or a borate.
<13> The method of producing an inkjet recording medium according to any one of <1> to <12>, wherein the wet coating amount of the first coating liquid is from 50 to 200 ml/m².
<14> The method of producing an inkjet recording medium according to any one of <1> to <13>, wherein the coating amount, in terms of solid content, of the first coating liquid is from 5 to 25 g/m².

All publications, patent applications, and technical standards mentioned in this specification are herein incorporated by reference to the same extent as if each individual publication, patent application, or technical standard was specifically and individually indicated to be incorporated by reference.

The disclosure of Japanese Patent Application No. 2010-048293, filed on Mar. 4, 2010, is incorporated herein by reference.

What is claimed is:

1. A method of producing an inkjet recording medium, the method comprising:
preparing a first coating liquid by mixing an aqueous solution of an acetoacetyl-modified polyvinyl alcohol with a zirconium compound-containing liquid comprising inorganic fine particles and a zirconium compound; and
forming a coating layer by applying the first coating liquid onto a substrate.

2. The method of producing an inkjet recording medium according to claim 1, wherein preparing the first coating liquid includes adjusting a pH of the zirconium compound-containing liquid to a value of from 4.5 to 6.

3. The method of producing an inkjet recording medium according to claim 1, further comprising curing the coating layer with crosslinking by applying thereto a second solution comprising an acidic compound either (1) at the same time as the application of the first coating liquid or (2) during drying of the coating layer formed by the application of the first coating liquid but before the coating layer shows falling-rate drying.

4. The method of producing an inkjet recording medium according to claim 1, further comprising, after the formation of the coating layer, cooling the coating layer and drying the cooled coating layer with dry air having a dew-point temperature that is at least 10° C. lower than the temperature of the cooled coating layer.

5. The method of producing an inkjet recording medium according to claim 1, wherein the zirconium compound comprises at least one selected from the group consisting of zirconyl hydroxy chloride, zirconyl chloride, zirconyl nitrate, zirconyl acetate, and ammonium zirconyl carbonate.

6. The method of producing an inkjet recording medium according to claim 2, wherein preparing the first coating liquid includes adjusting the pH of the zirconium compound-containing liquid by using ammonia or an ammonium compound.

7. The method of producing an inkjet recording medium according to claim 1, wherein the inorganic fine particles comprise at least one selected from silica fine particles, colloidal silica, alumina fine particles, or pseudoboehmite fine particles.

8. The method of producing an inkjet recording medium according to claim 1, wherein the degree of acetoacetyl modification of the acetoacetyl-modified polyvinyl alcohol is from 0.1 to 20 mol %.

9. The method of producing an inkjet recording medium according to claim 1, wherein the first coating liquid further comprises a water-soluble resin other than the acetoacetyl-modified polyvinyl alcohol.

10. The method of producing an inkjet recording medium according to claim 1, wherein, in the first coating liquid, a ratio by mass (PB ratio (x/y)) of the inorganic fine particles (x) to the water-soluble resin (y) (the acetoacetyl-modified polyvinyl alcohol and additional water-soluble resins, if any) is from 1.5 to 10.

11. The method of producing an inkjet recording medium according to claim 1, wherein the first coating liquid further comprises a crosslinking agent that is capable of crosslinking the acetoacetyl-modified polyvinyl alcohol.

12. The method of producing an inkjet recording medium according to claim 11, wherein the crosslinking agent is at least one selected from borax, boric acid, or a borate.

13. The method of producing an inkjet recording medium according to claim 1, wherein the wet coating amount of the first coating liquid is from 50 to 200 ml/m².

14. The method of producing an inkjet recording medium according to claim 1, wherein the coating amount, in terms of solid content, of the first coating liquid is from 5 to 25 g/m².
